(19) United States
(12) Patent Application Publication
(10) Pub. No.: US 2023/0329227 A1
(43) Pub. Date: Oct. 19, 2023

(54) WING HARNESS APPARATUS FOR WATERFOWL DECOY

(71) Applicant: George Parker, Santa Rosa, CA (US)

(72) Inventor: George Parker, Santa Rosa, CA (US)

(21) Appl. No.: 17/721,334

(22) Filed: Apr. 14, 2022

(51) Int. Cl. A01M 31/06

(52) U.S. Cl. CPC A01M 31/06

(57) ABSTRACT

An extendable wing harness apparatus for a wingless decoy is provided. The wing harness apparatus includes a decoy attachment element having a pair of attachment members, a forward body member comprised of a adjustable strap or string that attaches to the forward portion of the wing harness, and a rear attachment member similarly attached by an adjustable strap or string-to the wing harness, wherein a first attachment member of the pair of attachment members is configured to be removably attached to a neck of a decoy and a second attachment member of the attachment members is configured to wrap around the rear of the decoy, and a flexible wire extending from the forward portion of the wing harness to extend two wing-like wing appendages in opposite directions away and up from the wing harness.

### CROSS-REFERENCE TO RELATED APPLICATIONS

N/A

### BACKGROUND OF THE INVENTION

### 1. Field of the Invention

The present invention relates generally to waterfowl hunting accessories and more particularly to wing harness apparatus for waterfowl decoy.

### 2. Description of Related Art

When hunting waterfowl species, such as ducks and geese, users often setup devices called decoys, waterfowl decoys, goose decoys, duck decoys or similar, which is essentially a man-made device resembling a waterfowl species. It is well known that ducks and other waterfowl species are attracted to these devices when they are positioned on land, in a lake or anywhere waterfowl are known to travel. These decoys are useful to attract waterfowl from long distances. However, there is a common factor between many floating and land-bound decoys in their lack of extendable or attachable wings due their cumbersome and heavy-weight nature. Winged-decoys are known as full-body decoys. More decoys subsequently attract more birds to the hunter, and hunters must carry these decoys physically to their hunting area. Variety in the types, shapes and utility of the decoys is a very important aspect to success in the field of hunting waterfowl. A seasoned hunter must bring full-body decoys to have variety and increase success. As ‘full body’ decoys are cumbersome and heavy, hunters regularly default to utilizing wingless, lightweight molded decoys. Hunters currently have no portable, lightweight option to add wings to the decoys they own and are forced to buy cumbersome and heavy decoys to stay competitive in the hunting zone. Consequently, a solution is provided.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention to provide a collapsible, lightweight wing-printed attachment for a wingless decoy wherein the decoy comprises at least no extended wings to at most two wings molded into, not extended or away from, the body of the decoy to create organically animated wings without the use of a motor.

In order to do so an extendable winged-harness apparatus for a waterfowl decoy is provided, comprising a decoy attachment element, wherein the decoy attachment element is configured to be removably attached to waterfowl decoy using a harness; and, moldable wire in combination with appendages, which are printed with natural duck markings, coupled to the decoy attachment element configured to produce a life-like wingspan and positioned approximate to body of the floating decoy.

In one embodiment, the decoy attachment element comprises a pair of attachment members, wherein a first attachment member of the pair of attachment members is configured to be removably attached to the neck or forward body of the decoy and a second attachment member of the attachment members is configured to attach to the tail or rear body of the waterfowl decoy-holding the wing harness in between. In another embodiment, the body member is coupled to a bendable wire with attached wing-like appendages, wherein the wire is configured to be secured to the wing harness. In another embodiment, the wing-like appendages are expanded. In one embodiment, the wing-like appendages are collapsed.

In another aspect of the invention, an extendable wing harness apparatus for a waterfowl decoy positioned on land or the water surface is provided The wing harness apparatus comprising a decoy attachment element comprising a pair of attachment members, wherein a first attachment member of the pair of attachment members is configured to be removably attached to the body, or neck, of the decoy and a second attachment member of the attachment members is configured to wrap around the body, or rear, of the decoy; wing-like appendages are secured to the wing harness, wherein the wing-like appendages element is configured to be positioned approximate to the decoy's back; and, wherein a first mode of operation the wing-like element is configured to expand and retract the wing-like appendages element and another operation of the wing-like appendages element is to have customizable positioning utilizing the bendable wire attached to the wing-like appendages element.

In yet another aspect of the invention, a method to create life-like wingspan on a decoy is provided, comprising steps (a) positioning the duck, goose, or other waterfowl decoy on land or above land, on water surface or above the surface of the body of water, wherein the decoy has no wingspan, or shows the shape of a wingless bird; (b) attaching wings from a source other than the decoy itself; (c) coupling a decoy attachment element to the wingless decoy, wherein the decoy attachment element is configured to convert the wingless decoy into a winged decoy; (d) coupling winged element to the via the decoy attachment element; and, (e) securing a connection element to front and rear of the decoy body as a method to stabilize the decoy attachment element.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A a perspective view of an extendable wing harness apparatus for a waterfowl decoy according to an embodiment of the present invention.

FIG. 1B is a front view of FIG. 1A.

FIG. 2 is a perspective view of the decoy attachment element showing attachment element independently from the decoy in FIG. 1A.

FIG. 3 is a perspective view of the decoy attachment element independently from the connections shown in FIG. 2.

FIG. 4 is a top perspective view of collapsed wing positioning according to an embodiment of the present invention.

FIG. 5A is a perspective view of the wing harness apparatus independent from connections shown in FIG. 4.

FIG. 5B is a bottom perspective view the of FIG. 5A.

FIG. 6A is a perspective view of a portion of a decoy attachment element according to an embodiment of the present invention.

FIG. 6B is a perspective view of yet another portion of a decoy attachment element according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art since the general principles of the present invention have been defined herein to specifically provide a harnessed wing apparatus for a waterfowl decoy.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

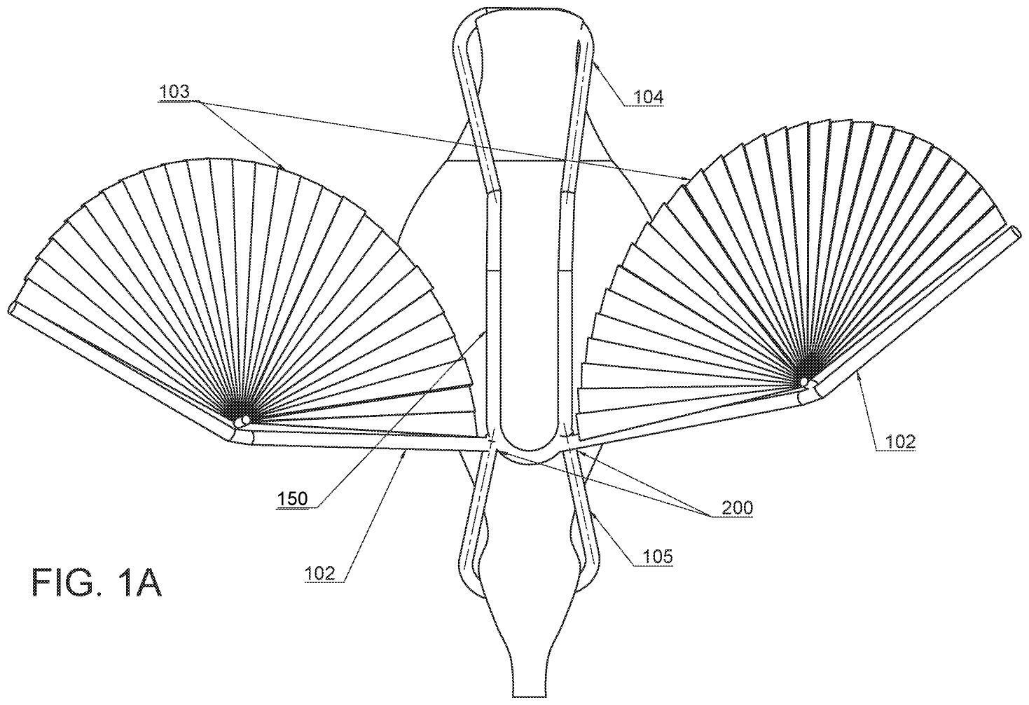

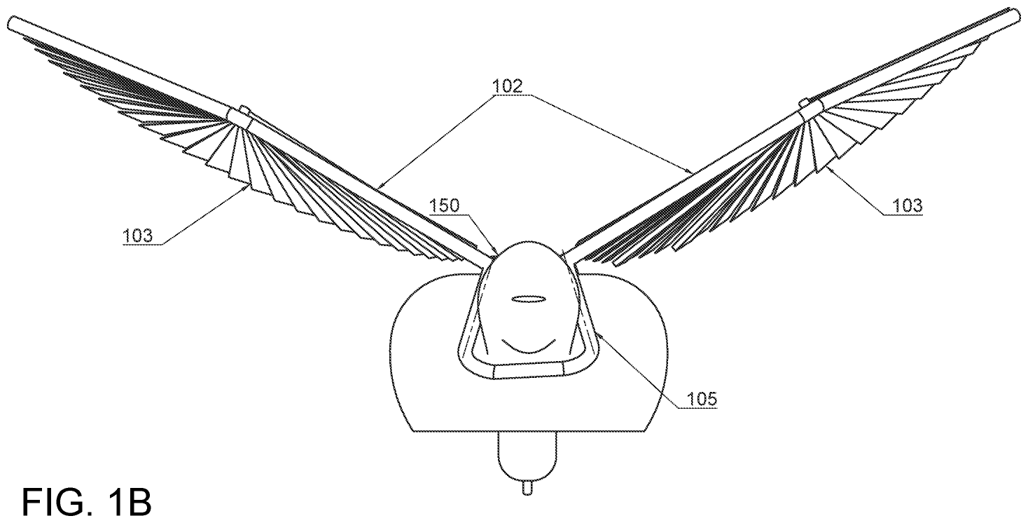

FIGS. 1A-B are various views of an extendable wing harness apparatus for a waterfowl decoy according to an embodiment of the present invention. Referring now to FIGS. 1A-B, the wing harness apparatus 150 is illustrated. The harness is comprised of connecting material which will be separated as harness location 150 and wing locations 102. In one embodiment, the wing harness apparatus 150 comprises a decoy attachment wire 102, and wing-like appendages 103. In one embodiment, the decoy attachment element includes a pair of stringed or strapped attachment members 104 and 105, wherein one attachment member 105 is configured to be coupled neck area of a waterfowl decoy, and the other attachment member 104 is configured to be coupled to the tail area of a waterfowl decoy to secure the harness 150. Simply put, the harnessed wing apparatus of the present invention attaches to connections connected to the front and rear body areas of the decoy, and more particularly the neck and tail area, which secures the harness to the decoy to provide stability for the wire and wing-like appendages. This will be discussed in further details below.

In one embodiment, each pair of attachment members 104 and 105 includes a bendable wire 102, wherein the harness 150 is either attached, coupled, or formed with each respective attachment member. The wire 102 is uniquely attached to the wing-like appendages 103. The point 200 is the location of flexible motion caused by the bendable nature of the wire 102 where it meets the harness 150 and creates a natural wind and wave-driven motion discussed in further details below.

Still referring to FIGS. 1A-B, the wing-like appendages 103 are configured to be attached or coupled to the bendable wire 102 via the harness 150. The means of attachment may be any attachment method known in the art, including but not limited to, a threaded connection, interference fit, magnetic connection, fasteners, etc. Preferably, it is an attachment method that is easy to disconnect the wings from the lower attachment member for ease of transportation, storage, and installation. In one embodiment, the wire 102 includes a top portion 102 and a harness portion 150. In some embodiments, the harness 150 is configured to be touching the decoy surface when in use, in other embodiments, the harness may be attached in other locations of the decoy's surface.

To create the real wing effect during use, a, natural patterned wing 103 is provided. In one embodiment, the wing 103 comprises a framed waterfowl wing pattern and flexible wire 102 and harness 150. In some embodiments, the position of the wings along the wire may vary and is adjustable by the user. In one embodiment, the wings are positioned such that wings are collapsed and is portable. In other embodiments, the wings 103 may be positioned open or partially opened. As the apparatus is in use and the fan will be opened, it will be placed in a particular position by the user to allow create a true bird look and feel.

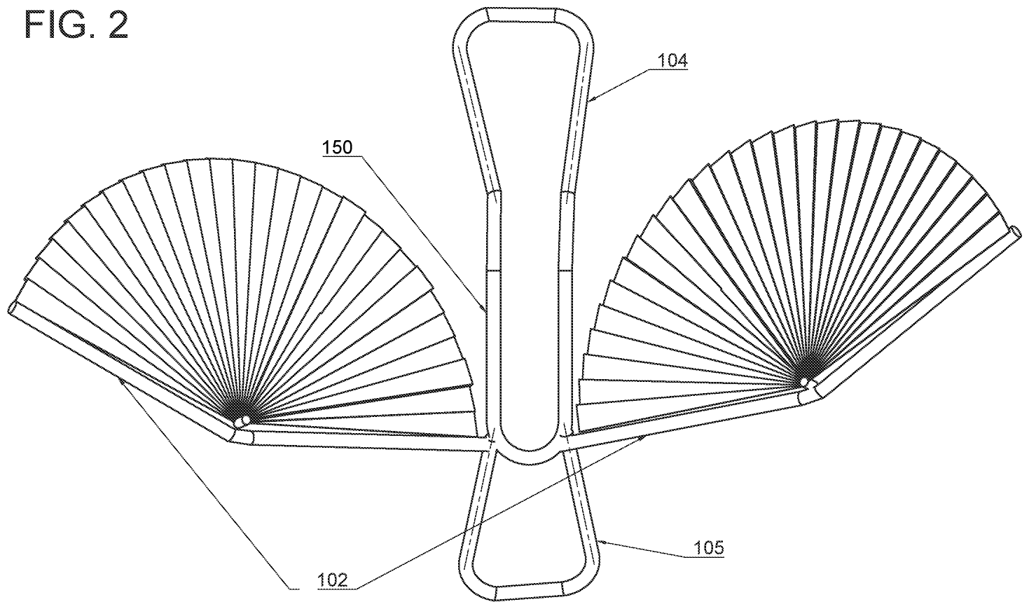

Referring now to FIG. 2, the decoy attachment harness 150 is illustrated attached to the flexible wire 102. The pair of attachment members 104 and 105 are also illustrated with the harness 150. It should be noted, that in alternative embodiments, the connections 104 and 105 and the wire 102 may directly attach to body member harness 150 and the functionality of the apparatus would be similar. Further, the wire 102 in combination with attachment members 104 and 105 enables ease of installation and removal of the harness 150.

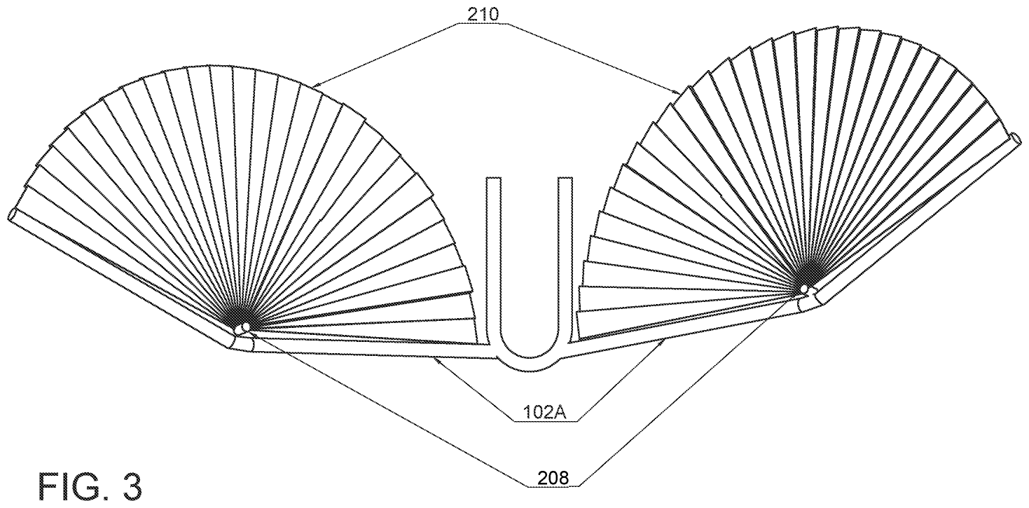

FIG. 3 shows various perspective views of the wing. Like the wing previously discussed, the wings 103 includes a connecting member 208 and flexible wire 102. In some embodiments, the wing 103 comprises an image of an extendable wing and feathers of varying colors 210. Advantageously, the array of feathers and colors 210 are configured to create a true wing feel and look. In one embodiment, the wing is extended to provide a particular emotion of the decoy. It should be understood, that although one wing image was provided, others may be realized without departing from the spirit or scope of the invention. Conceptually the following characteristics are important for the wings: (a) having a shape which simulates the true shape and color of a true bird wing; (b) configured to be adjustably positioned by height (or length) of the wire; and (c) optionally opening or closing the nature of the wing to change the shape or store the wing away when not in use. It should be understood, that although an extendable wing-like shape was illustrated and described, the wing may be any shape known the art that provides the aforementioned characteristics, including but not limited to, square, round, circular, ball, irregular, triangular, polygonal, or similar.

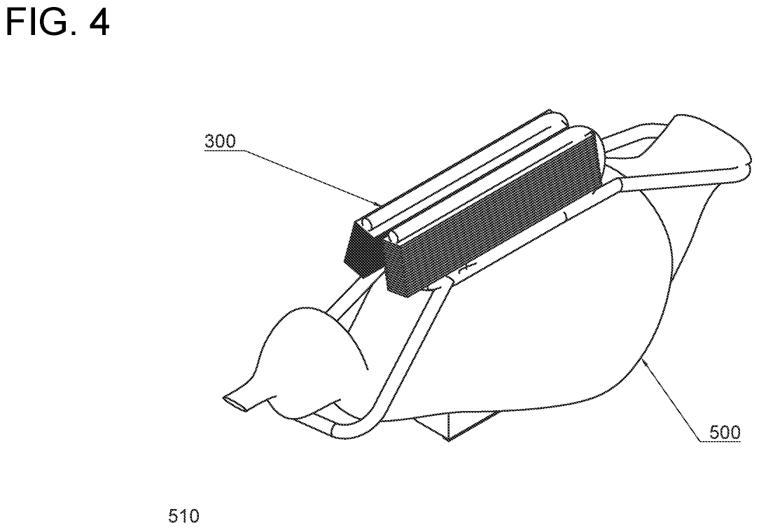

Referring now to FIG. 4, the entire harness apparatus 300 is shown installed and attached to an existing waterfowl decoy 500. In one embodiment, the apparatus is collapsed yet still attached to a decoy configured to be wingless when positioned in a body of water or above land 510, i.e., the apparatus is intended for use with waterfowl decoys that do not provide any extended or connected wings. That said the apparatus may be used on any waterfowl decoy that has a no wings, or wings that are permanently molded into a resting, or un-extended position.

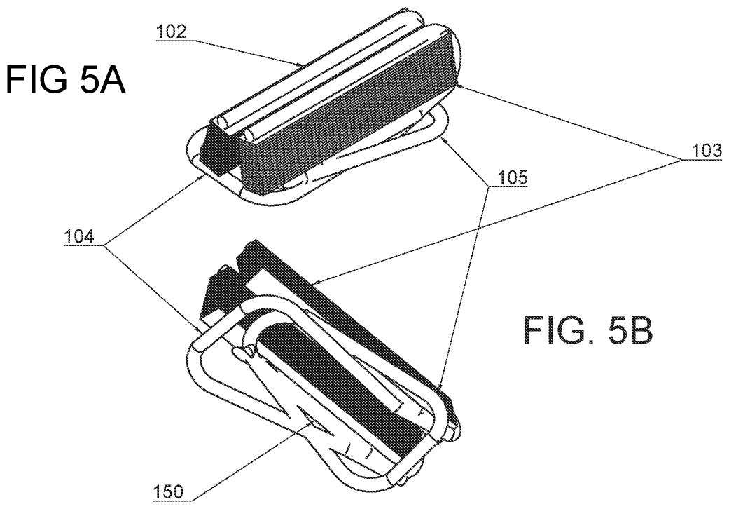

Referring now to FIGS. 5A-B, the decoy attachment harness 150 is illustrated attached to the flexible wire 102. The wings 103 are shown completely collapsed. The pair of attachment members 104 and 105 are also illustrated with the harness 150.

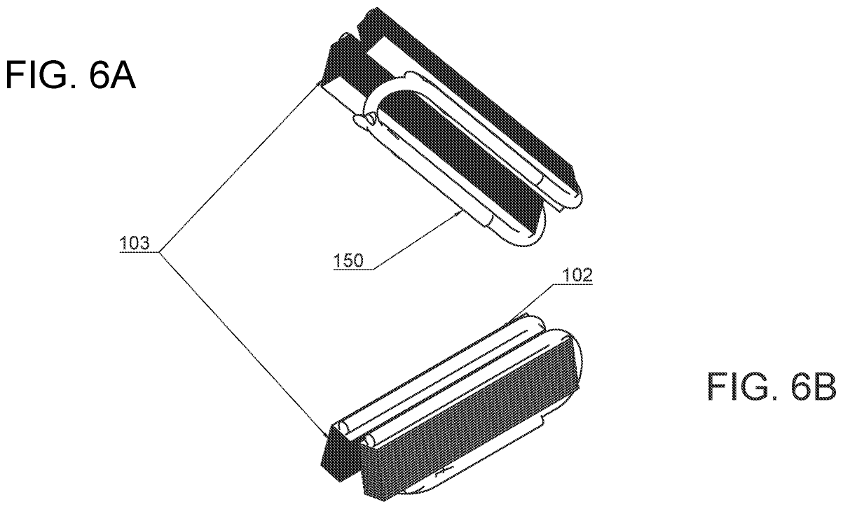

Referring now to FIGS. 6A-B, the decoy attachment harness 150 is illustrated attached to the flexible wire 102. The wing-like appendages 103 are shown completely collapsed independently without the pair of attachment members 104 and 105 illustrated in FIG. 5A-B.

Referring to any of the accompanying FIGS. 1-6, the wing-like appendage apparatus 103 is attached to the back of the decoy 500 via decoy attachment elements 104 and 105, and more particularly attachment wing harness 150. Next, the strap or string 104 is positioned on the neck or forward body of the decoy 500 such that the harnessed wing is configured to be held forward on the back 500. Now, the strap or string 105 is positioned on the tail or rear body of the decoy 500 such that the wing harness is configured to be held backward on the back of the decoy 500. Advantageously, as the connections 105 and 104 are pulled against each other, the wing harness 150 is held firmly in place allowing the wing-like appendages 103 to hold in flexible position to create an extendable wingspan of a natural bird. Another advantage of the present invention is the life-like presence when wind or waves are added to the decoy presentation; these wings will catch the wind, moving the decoy around the hunting area like a live bird. Similarly, with waves, the flexible nature of the wire wing harness allows for wave-driven flapping-wing movement, further accentuating the actions of the decoy to simulate a true live bird. Furthermore, yet another advantage of the present invention is the wing-like appendages are collapsible, creating a packable device that is ⅙th the width of the fully extended wings. A current issue with rigid-winged decoys is that they are cumbersome and impractical to bring to a hunting situation. In these situations, the hunter is unable to travel with anything other than wingless, shelled decoys. Thus, the addition of this invention to an extendable wingless shell decoy creates a much more natural presence in the decoy layout, attracting more birds for the hunter.

Another advantage of the present invention is the apparatus does not require the user to purchase a complete decoy system. Rather the user may utilize their existing decoys, removing the need to purchase additional decoys that ‘work’ with the apparatus. Another advantage of the present invention is the appearance created from the apparatus will provide differences in decoy presence to any other wingless decoys that have been placed in the decoy presentation, increasing the effectiveness of all decoys in the presentation. Again, to reiterate, decoys are far less effective with no wings, as true live birds at times spread their wings to stretch, bathe and fight. This invention solves this issue when the entire decoy spread has identical, wingless birds.

It should be understood that there are many different brands of wing waterfowl decoys available, including but not limited to, decoys from Mojo®, Avian X®, and Lucky Duck®, and as a result the size, shape, and connection method of the pair of attachment members 104 and 105 will vary depending on which brand is used. For example, in some embodiments, attachment members utilize a slip-knot connection. In other embodiments, the attachment members utilize an elastic attachment. Yet in other embodiments, the connection is magnetic. Several versions may be provided to the user such that the apparatus can be used with any brand of waterfowl decoy. Further the spinning waterfowl decoy may be positioned on land, anchored into a ground surface below the water via a stake, or float on the surface of the water.

Any materials as well known in the art may be used and selected for their specific properties. The apparatus may include a combination of materials, including but not limited to metals, plastics, wood, rubber, synthetic or natural cloths etc.

For the purposes of the claims, the attachment members for forward and rear straps or strings may be defined as forward or rear connections as they connect the wing harness to the decoy. In the same spirit, the wings may be defined as an extendable wing-like apparatus element as its function is to create a natural wingspan on a wingless decoy.

FIGS. 5A-B show two alternative embodiments of portions a decoy attachment element (104/105) with the pair of attachment members removed. Illustrated are the neck attachment member and tail attachment member of the decoy attachment element.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

For example, although an extendable wing harness is provided, the wing harness may be replaced with a magnet or sticky object. Further, the wing-like apparatus may be combined and built-in to its own waterfowl decoy where the collapsible decoy attachment element is fixed or part of the waterfowl decoy. Similarly, the apparatus may be presented with different wings, such as a stand-alone paper and wire. Also, the nature of the wings may be partially rigid (as opposed to the collapsible nature as previously discussed) to pack away into a portable storage.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An extendable wing harness apparatus for a waterfowl decoy comprising:
a decoy attachment element, wherein the decoy attachment element is configured to be removably attached to the waterfowl decoy; and,
a bendable wire coupled to the decoy attachment element configured to hold a pair of wing-like appendage elements.

2. The wing harness apparatus of claim 1, wherein the forward attachment member is configured to be secured to a front portion of a body or a neck of the waterfowl decoy and the rear attachment member is configured to be secured to a rear portion of the body of the waterfowl decoy.

3. The wing harness apparatus of claim 3, wherein the body member is coupled to the bendable wire, further comprises the wing-like appendages configured to be secured to the bendable wire at a desired position while attached to the wing harness.

4. The wing harness apparatus of claim 1, wherein the wing harness is flexible and ‘U’ shaped.

6. A method to attach an extendable wing-like apparatus to a waterfowl decoy, comprising steps:
(a) positioning the waterfowl decoy on land or at, or above, a water surface, wherein the waterfowl decoy comprises at most no extended wings to at most two wings molded into, not extended or away from, the body of a waterfowl decoy;
(b) placing an extendable wing harness on the back, body or belly, of the waterfowl decoy;
(c) coupling two decoy attachment elements to the waterfowl decoy, wherein the two decoy attachment elements are configured to be attached to the wing harness and wrap around a front portion and a rear portion of a body of the waterfowl decoy.
(d) extending a pair of wing-like appendages away from the wing harness to simulate a wingspan.
